(19) United States
(12) Patent Application Publication
(10) Pub. No.: US 2011/0131531 A1
(43) Pub. Date: Jun. 2, 2011

(54) Touch Friendly Applications in an Information Handling System Environment

(76) Inventors: Deborah Russell, Austin, TX (US); Angela Blair, Leander, TX (US); Keith Kozak, Round Rock, TX (US)

(21) Appl. No.: 12/629,228

(22) Filed: Dec. 2, 2009

(51) Int. Cl. G06F 3/048; G06F 3/033

(52) U.S. Cl. 715/835; 715/863

(57) ABSTRACT

A dynamic touch interface in which users are able to flick or scroll within the dynamic touch interface such as a dock or carousel and view the contents of their applications and thus provides a touch friendly environment to a personal computer type operating system (i.e., a keyboard/mouse input type operating system). More specifically, the touch input environment implements dynamic icons such that the icons populate content which is viewed or experienced. For example, if a user launches a favorite band in a music application, the carousel is automatically populated with album art or a picture of the band. The next time the user visits the desktop, the music icon is replaced by an image of the band or artist. Also, in certain embodiments, the icon includes a brief description of the content (i.e., number of songs or albums in folder).

### BACKGROUND OF THE INVENTION

1. Field of the Invention

The present invention relates to information handling systems and more particularly to providing touch friendly applications for use with information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide information handling systems with touch sensitive display devices. In known information handling system, a large percentage of consumer touch devices have focused on either small handheld devices or larger tablets or all in one form factory type information handling systems. Depending on the product, developers may develop their own operating systems or leverage an existing, not touch friendly operating system for use with these devices. Those who leverage an existing operating system are often confined to relying on the operating system or in-house applications to deliver a compelling touch experience. While developing an operating system that is dedicated for a touch experience may be a desirable goal, it is often not feasible due to a variety of development constraints.

Accordingly, it would be desirable to enable a compelling interaction for touch input in a typical keyboard/mouse input type operating system. It would also be desirable to facilitate discoverability and innovation of the visualization and navigation of applications that execute within this typical keyboard/mouse input type operating system.

### SUMMARY OF THE INVENTION

In accordance with the present invention, a dynamic touch interface is set forth in which users are able to flick or scroll within the dynamic touch interface such as a dock or carousel and view the contents of their applications and thus provides a touch friendly environment to a personal computer type operating system (i.e., a keyboard/mouse input type operating system). More specifically, in certain embodiments, the touch input environment implements dynamic icons such that the icons populate content which is viewed or experienced. For example, if a user launches a favorite band in a music application, the carousel is automatically populated with album art or a picture of the band. The next time the user visits the desktop, the music icon is replaced by an image of the band or artist. Also, in certain embodiments, the icon includes a brief description of the content (i.e., number of songs or albums in folder).

This dynamic interface touch environment addresses an issue of known computer system user interface interaction, delights the user with a tangible user interface, and offers a personalized user experience. Users have the ability to personalize their interface with their own content. Additionally, in certain embodiments, the dynamic interface touch environment may be customized to targeted demographics, such as family, teens, social networking, and gamers.

The dynamic interface touch environment differentiates from known desktop type computer system user interfaces with one that is more inviting for touch. More specifically, dynamic interface touch environment implements a dynamic interface and menu that houses applications. The interface is dynamic and shows application content rather than static iconography. In addition, users can access applications directly via a desktop screen presentation of the dynamic interface touch environment rather than a shelled environment.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a flow chart of the operation of a dynamic interface touch environment in an information handling system environment.

FIG. 3 shows a diagrammatic block diagram of an example interface of the dynamic interface touch environment in an information handling system environment.

FIG. 4 shows a sample screen presentation of an example interface of the dynamic interface touch environment in an information handling system environment.

FIG. 5 shows another sample screen presentation of example interface of the dynamic interface touch environment having generic icons.

FIG. 6 shows another sample screen presentation of an example interface of the dynamic interface touch environment having user content icons.

### DETAILED DESCRIPTION

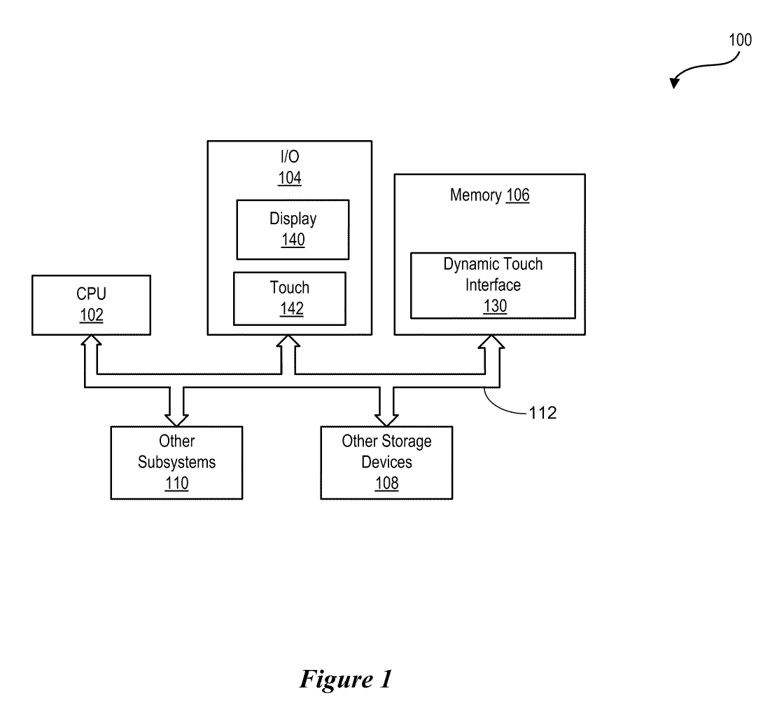

Referring briefly to FIG. 1, a system block diagram of an information handling system 100 is shown. The information handling system 100 includes a processor 102, input/output (I/O) devices 104, such as a display, a keyboard, a mouse, and associated controllers (each of which may be coupled remotely to the information handling system 100), a memory 106 including volatile memory such as random access memory (RAM) and non-volatile memory such as a hard disk and drive, and other storage devices 108, such as an optical disk and drive and other memory devices, and various other subsystems 110, all interconnected via one or more buses 112.

The information handling system 100 further includes a dynamic touch interface 130 which is stored on the memory 106 and executed by the processor 102. The I/O devices 104 can include a display 140 as well as a touch input device 142. The touch input device 142 may be integrated into the display such that the display is a touch sensitive display device.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

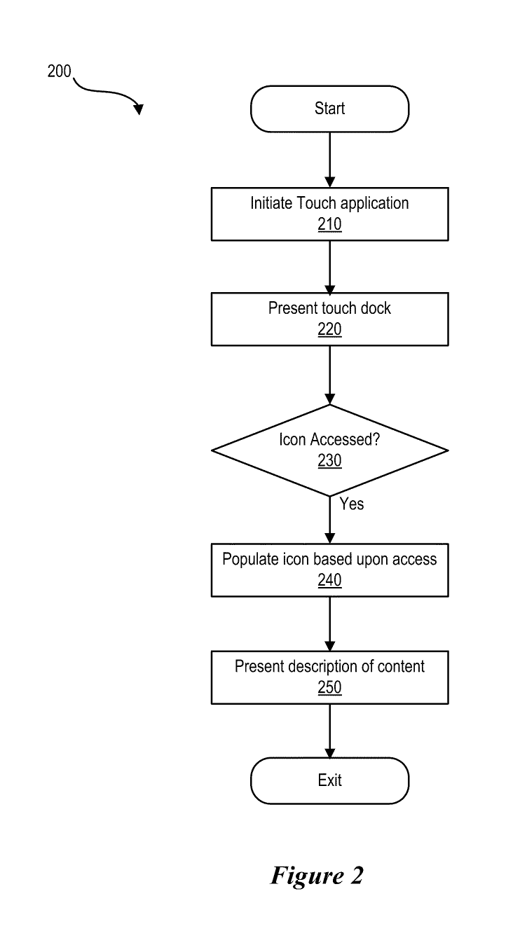

Referring to FIG. 2, a flow chart of the operation of a dynamic touch interface 200 in an information handling system is shown.

More specifically, the touch application is initiated at step 210. When the touch application is initiated at step 210, touch accessible icons are presented on the touch sensitive display 140 of the information handling system 100 at step 220. In certain embodiments, the touch accessible icons may be presented in a dock or carousel type arrangement. Next, the dynamic touch interface determines whether an icon is actuated by a user, e.g., by a user touching the icon presentation on the display 140. Next, the dynamic touch interface 200 dynamically populates content which corresponds to the accessed icon at step 240. Next, at step 250, the icon includes a brief description of the content (i.e., number of songs or albums that are contained in folder accessed by the icon).

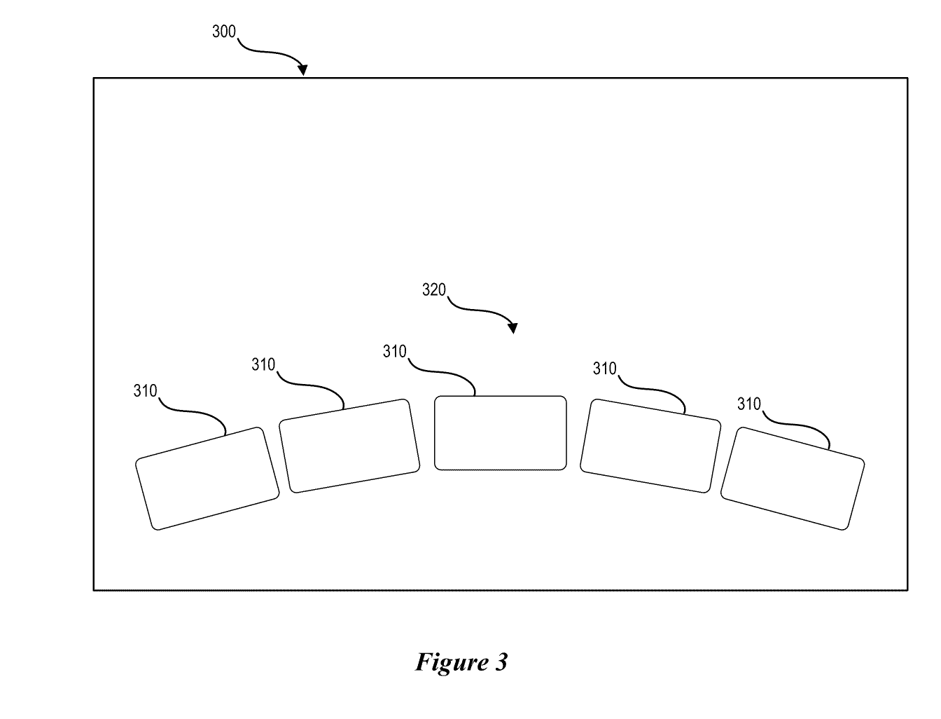

FIG. 3 shows a diagrammatic block diagram of an example interface 300 of the dynamic interface touch environment in an information handling system environment. The dynamic interface touch environment allows users to flick or scroll within the dynamic interface touch environment such as a carousel 320 (or deck, not shown in FIG. 3) and view the contents of their applications. The touch input environment implements dynamic icons 310. The dynamic icons 310 dynamically populate content which is viewed or experienced by a user.

This dynamic touch interface addresses an issue of known computer system user interface interaction, delights the user with a tangible user interface, and offers a personalized user experience. Users have the ability to personalize their interface with their own content.

The dynamic touch interface differentiates from known desktop type computer system user interfaces with one that is more inviting for touch. More specifically, the dynamic touch interface implements a dynamic interface and menu that houses applications. The interface is dynamic and shows application content rather than static iconography. In addition, users can access applications directly via a desktop screen presentation of the dynamic interface touch environment rather than a shelled environment. Additionally, launching an icon is input agnostic. Accordingly even though the dynamic interface is inviting for touch, an icon can be actuated via touch, remote control, mouse, touchpad, keyboard, etc. The dynamic touch interface presents a touch experience that is inviting and different on a desktop without requiring a user to access a shelled environment.

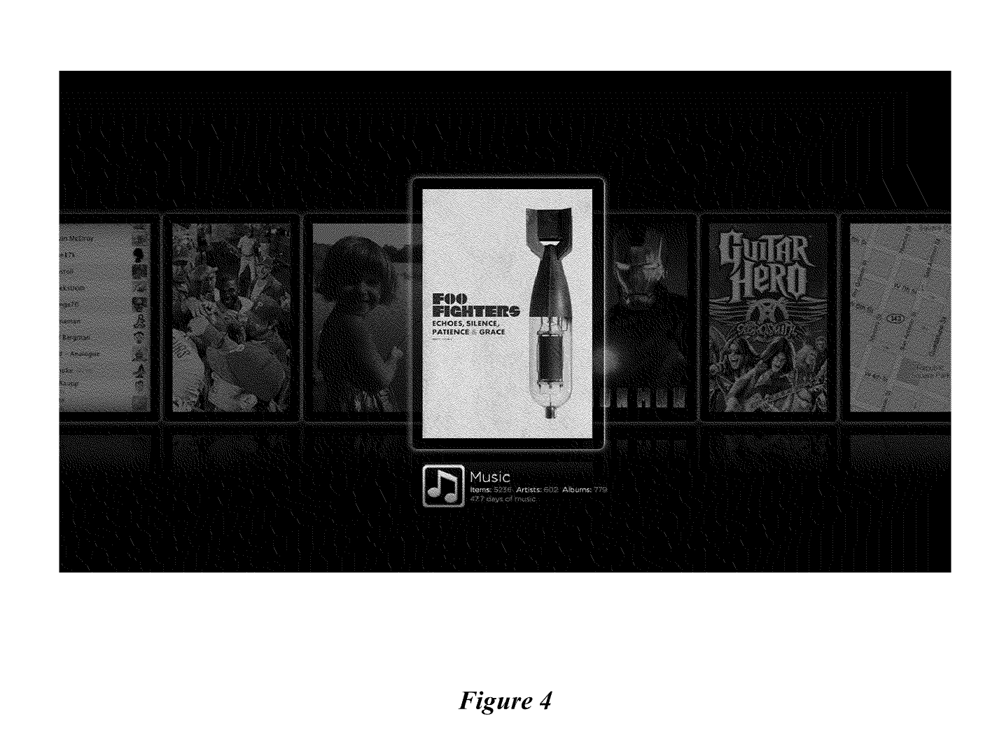

Referring to FIG. 4, a sample screen presentation of the dynamic touch interface 400 is shown. For example, if a user launches a favorite band in a music application, the icon from the deck of icons is automatically populated with album art or a picture of the band. The next time the user visits the desktop which includes the dynamic interface 400, the music icon is replaced by an image of the band or artist. Also for example, with respect to a web icon, the web icon may be populated with a particular website presentation (or portion thereof). The particular website presentation may be a user defined website, may be a most recently accessed website or may be updated at regular intervals. In each case, the image of the website may be captured and cropped into the icon container.

Also, the screen presentation of the icon presents a brief description of the content (i.e., number of songs or albums that are contained in folder accessed by the icon). Also, when an icon is selected by a user (e.g., by the user touching the icon), the selected icon is accented. E.g., in certain embodiments, the icon is enlarged relative to the other icons and presented with an appearance that the selected icon is closer to the user.

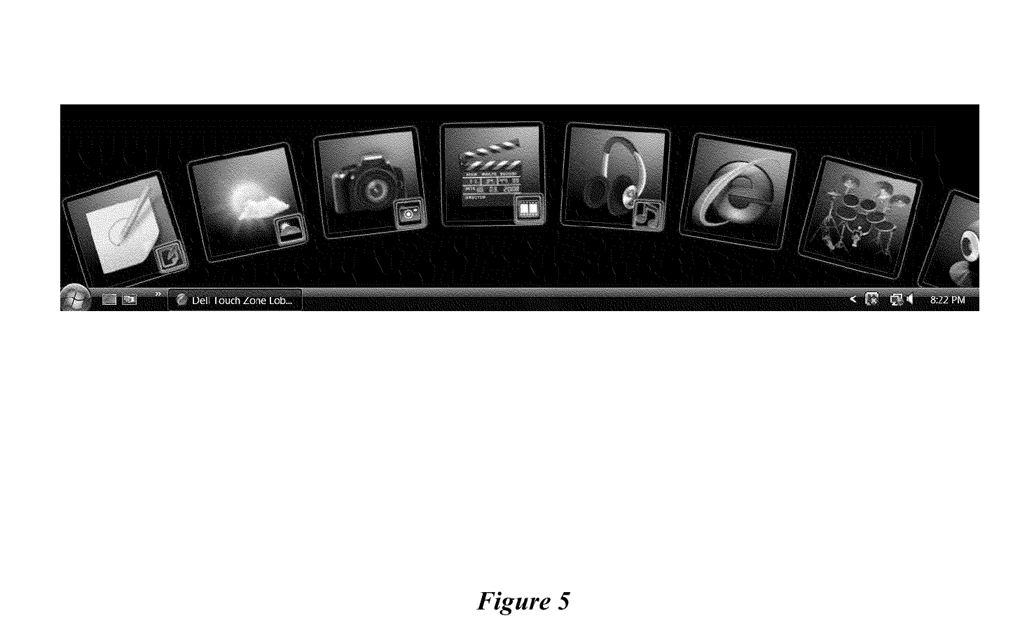

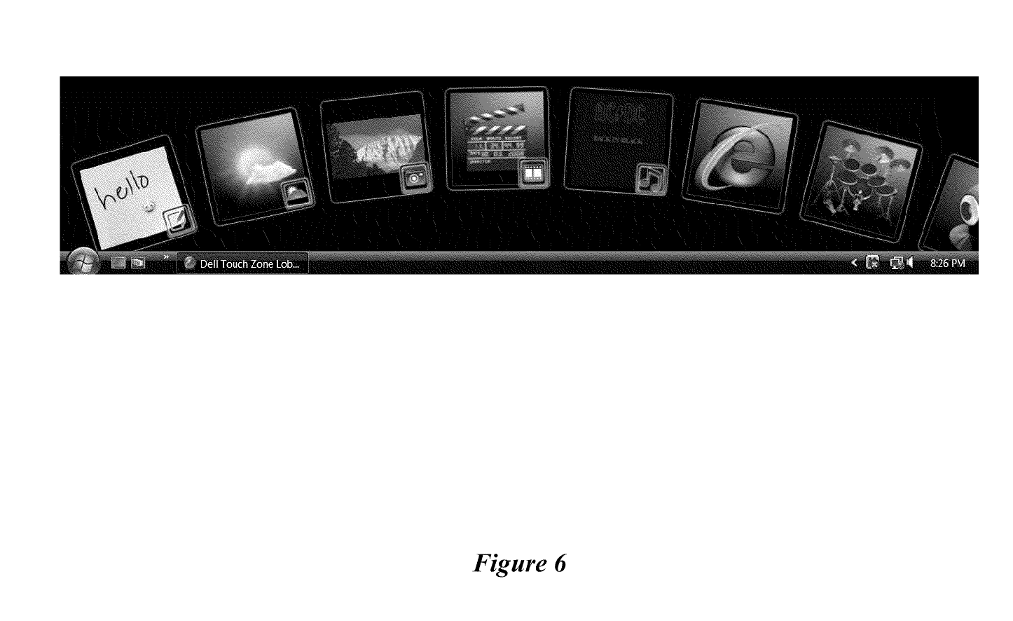

Referring to FIGS. 5 and 6, other sample screen presentations of example interface of the dynamic interface touch environment in an information handling system environment are shown. More specifically, FIG. 5 shows a sample screen presentation with generic icons while FIG. 6 shows a sample screen presentation with the generic icons replaced by user content (e.g., sticky notes, photo icons and music icons). For example, if a user launches a favorite band in a music application, the icon from the deck of icons is automatically populated with album art or a picture of the band. The next time the user visits the desktop which includes the dynamic interface, the music icon is replaced by an image of the band or artist. Also for example, the icons can access document folders. If an icon access a document folder, then the icon can be dynamically populated with a last object that was accessed or viewed within the folder (e.g., a word processing document or file name)

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, in certain embodiments, the dynamic interface touch environment may be customized to targeted demographics, such as family, teens, social networking, and gamers. The customization may include specialized icons that are presented via the dynamic interface.

Also for example, the icons may include a web icon. With a web icon, the web icon may be populated with a particular website presentation (or portion thereof). The particular website presentation may be a user defined website, may be a most recently accessed website or may be updated at regular intervals. In each case, the image of the website may be captured and cropped into the icon container.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for providing a dynamic touch interface comprising:
presenting a dynamic touch interface on a touch sensitive display device of an information handling system, the dynamic touch interface comprising a plurality of touch sensitive icons;
enabling a user to navigate through the plurality of touch sensitive icons via touch; and,
dynamically populating the plurality of touch sensitive icons based upon content accessed via the icon.

2. The method of claim 1 wherein:
navigating through the plurality of icons is via one of a flick touch and a scroll touch.

3. The method of claim 1 wherein:
the dynamic icons are arranged in one of a dock configuration and a carousel configuration.

4. The method of claim 1 wherein:
each of the plurality of dynamic icons further comprises a respective description of content accessed by a respective dynamic icon.

5. The method of claim 1 wherein:
a dynamic icon is accented when actuated by the user.

6. An apparatus for providing a dynamic touch interface comprising:
means for presenting a dynamic touch interface on a touch sensitive display device of an information handling system, the dynamic touch interface comprising a plurality of touch sensitive icons;
means for enabling a user to navigate through the plurality of touch sensitive icons via touch; and,
means for dynamically populating the plurality of touch sensitive icons based upon content accessed via the icon.

7. The apparatus of claim 6 wherein:
navigating through the plurality of icons is via one of a flick touch and a scroll touch.

8. The apparatus of claim 6 wherein:
the dynamic icons are arranged in one of a dock configuration and a carousel configuration.

9. The apparatus of claim 6 wherein:
each of the plurality of dynamic icons further comprises a respective description of content accessed by a respective dynamic icon.

10. The apparatus of claim 6 wherein:
a dynamic icon is accented when actuated by the user.

11. An information handling system comprising:
a processor;
a touch sensitive display device coupled to the processor;
a memory coupled to the processor, the memory storing a system for providing a dynamic touch interface, the system comprising instructions executable by the processor for:
presenting a dynamic touch interface on the touch sensitive display device, the dynamic touch interface comprising a plurality of touch sensitive icons;
enabling a user to navigate through the plurality of touch sensitive icons via touch; and,
dynamically populating the plurality of touch sensitive icons based upon content accessed via the icon.

12. The information handling system of claim 11 wherein:
navigating through the plurality of icons is via one of a flick touch and a scroll touch.

13. The information handling system of claim 11 wherein:
the dynamic icons are arranged in one of a dock configuration and a carousel configuration.

14. The information handling system of claim 11 wherein:
each of the plurality of dynamic icons further comprises a respective description of content accessed by a respective dynamic icon.

15. The information handling system of claim 11 wherein:
a dynamic icon is accented when actuated by the user.
